(19) United States
(12) Patent Application Publication
(10) Pub. No.: US 2003/0121384 A1
(43) Pub. Date: Jul. 3, 2003

(54) Paper punch

(76) Inventor: Chien-Fu Lin, Taichung City (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/035,267

(22) Filed: Jan. 3, 2002

(51) Int. Cl. B26F 1/14

(52) U.S. Cl. 83/622; 83/633; 83/687

(57) ABSTRACT

A paper punch includes a base and a raised portion extends from a top of the base. A handle is pivotally connected to the base. Two passages are defined through the raised portion and two punch head assemblies are respectively received in the two passages. Each punch head assembly includes a post and a punch blade. A lower edge of each of the punch blades has two tips and a recess is defined longitudinally in a lower end of each of the punch blade. A spring is engaged in each of the recesses of the two punch blades.

### FIELD OF THE INVENTION

The present invention relates to a paper punch that has two push heads each have two sharp tips and are located at different levels.

A conventional paper punch generally includes a base with a handle pivotally connected thereto and two punch heads are vertically movably connected to the handle so that when pushing the handle, the punch heads punch holes through papers. The lower edge of each of the punch heads is usually machined to be rounded and the two lower edges are located at the same levels. When proceeding punching, the two lower edges contact the paper simultaneously so that the resistance is huge and the user has to push the handle hard to punch through the papers. The punch heads can only punch thin bunch of papers because of the rounded lower edges.

### SUMMARY OF THE INVENTION

In accordance with one aspect of the present invention, there is provided a paper punch which comprises a base and a raised portion extending from a top of the base. A gap is defined between the top of the base and the raised portion. A handle is pivotally connected to the base. Two passages are defined through the raised portion so as to receive two punch head assemblies therein. Each punch head assembly includes a post and a punch blade. A lower edge of each of the punch blades has two tips and a recess is defined longitudinally in a lower end of each of the punch blade. A spring is engaged in each of the recesses of the two punch blades.

The primary object of the present invention is to provide a paper punch that has two punch blades with different lengths so as to contact papers at different times to reduce the resistance when punching.

Another object of the present invention is to provide a paper punch wherein the position of one of the two punch assemblies can be adjustable.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the paper punch of the present invention;

FIG. 2 is an end view to show the punch blades of the paper punch of the present invention have different lengths;

FIG. 3 shows that one of the punch blades contacts the paper first when pushing the handle;

FIG. 4 shows that the other punch blade punches the paper right after the first one penetrates through the paper;

FIG. 5 is an exploded view to show the other embodiment of the paper punch of the present invention, and

FIG. 6 shows that one of the punch head assemblies is positioned by contact a protrusion of a positioning member and a rod extends from the punch head assembly.

### DETAILED DESCRIPTION OF THE PREFERRED EMBODIMENT

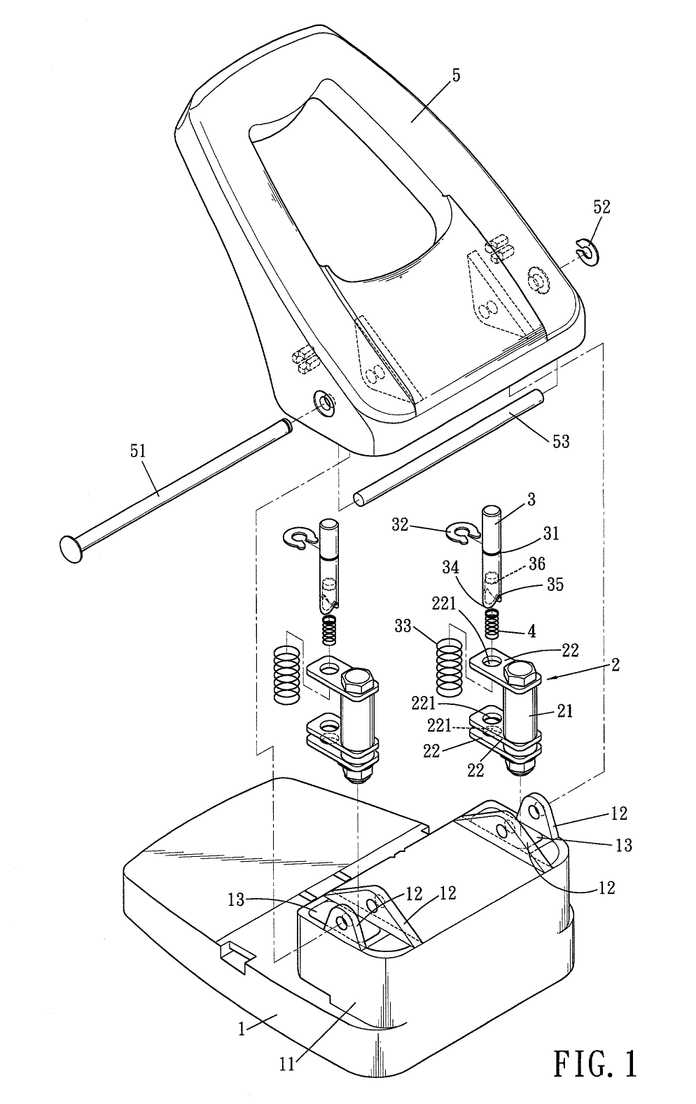

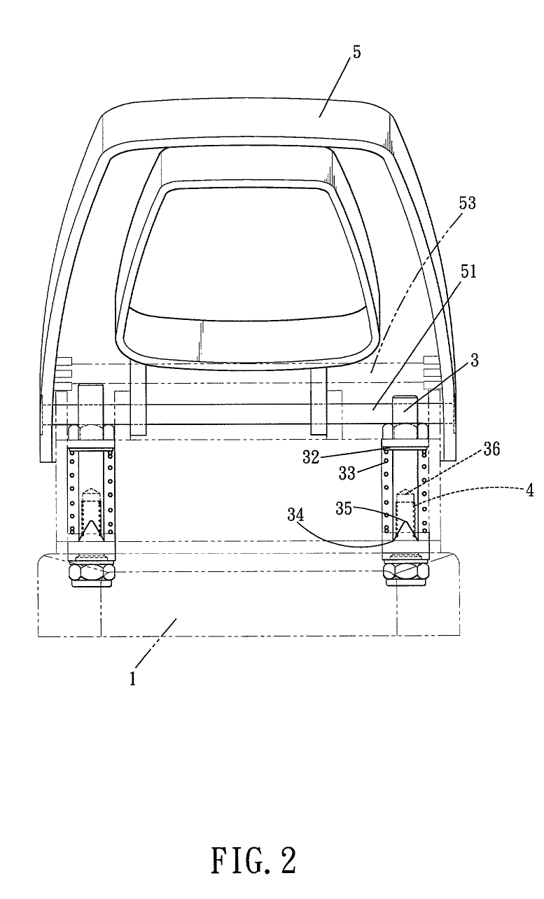

Referring to FIGS. 1 and 2, the paper punch of the present invention comprises a base 1 and a raised portion 11 extends from a top of the base 1. A handle 5 is pivotally connected to lugs 12 on the base 1 by a pin 51 and a gap is defined 5 between the top of the base 1 and the raised portion II so that papers to be punched can be inserted in the gap. Two passages 13 are defined through the raised portion 11 and two punch head assemblies 2 are respectively received in the two passages 13.

Each punch head assembly 2 includes a post 21 and a punch blade 3. Three plates 22 are mounted to the post 21 of each of the punch head assemblies 2 and the punch blade 3 extends through holes 221 in the three plates 22. One plate 22 is mounted on a top end of the post 21 and the other two plates 22 are mounted on a lower end of the post 21. A C-clamp 32 is mounted to a groove 31 of each of the punch blades 3 and is located at an underside of the plate 22 mounted on the top of the post 21. A spring 33 is mounted to the punch blade 3 and located between the plate 22 on the top end of the post 21 and the two plates 22 on the lower end of the post 21. A lower edge 35 of each of the punch blades 3 has two tips 34 and a recess 36 is defined longitudinally in a lower end of each of the punch blade 3. A spring 4 is engaged in each of the recesses 36 of the two punch blades 3. An operation bar 52 is received in the handle 52 and is used to push the two punch blades 3 when pivoting the handle 5.

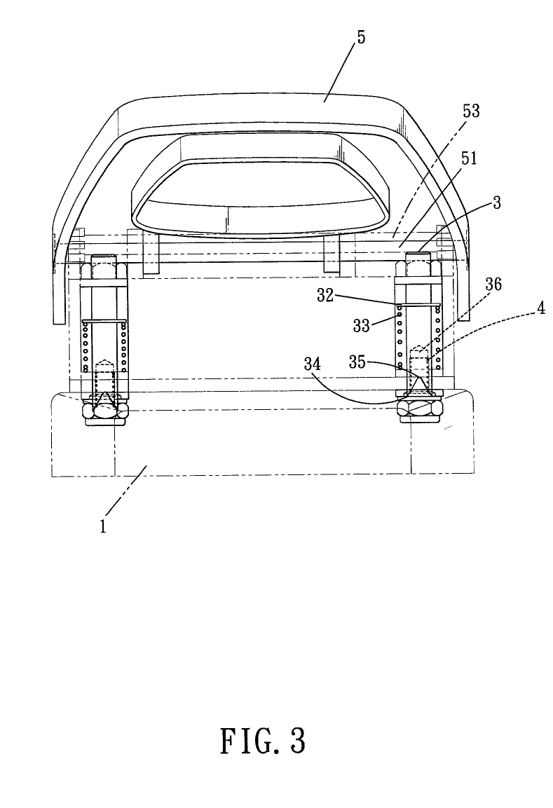

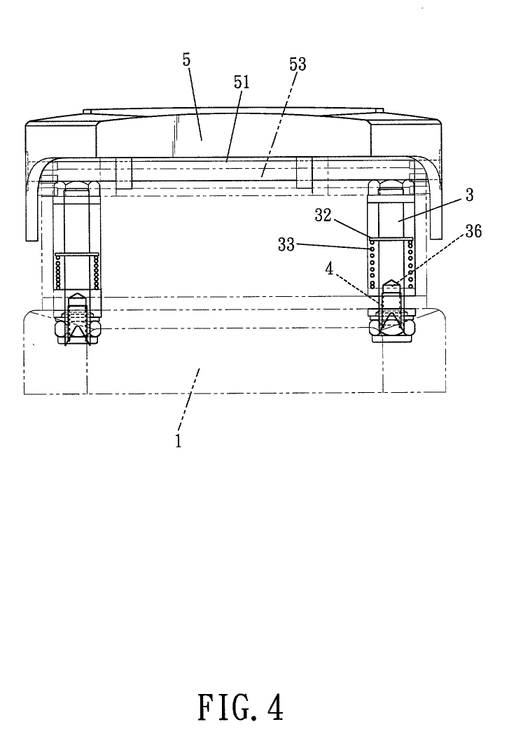

The two punch blades 3 are different in length and two respective top ends of the two punch blades 3 are located at different levels. The operation bar 52 is located above the two respective top ends of the two punch blades 3. As shown in FIGS. 3 and 4, when pivoting the handle 5, the operation bar 52 first moves the longer punch blade 3 to punch the papers and then the other punch blade 3 is pushed by the operation bar 52 to punch the papers. The resistance orL punching is reduced because there are two tips 34 which are able to penetrate in the papers so that the punch is able to punch a thicker bunch of papers. The debris of the punching will be pushed out from the recesses 36 by the springs 4.

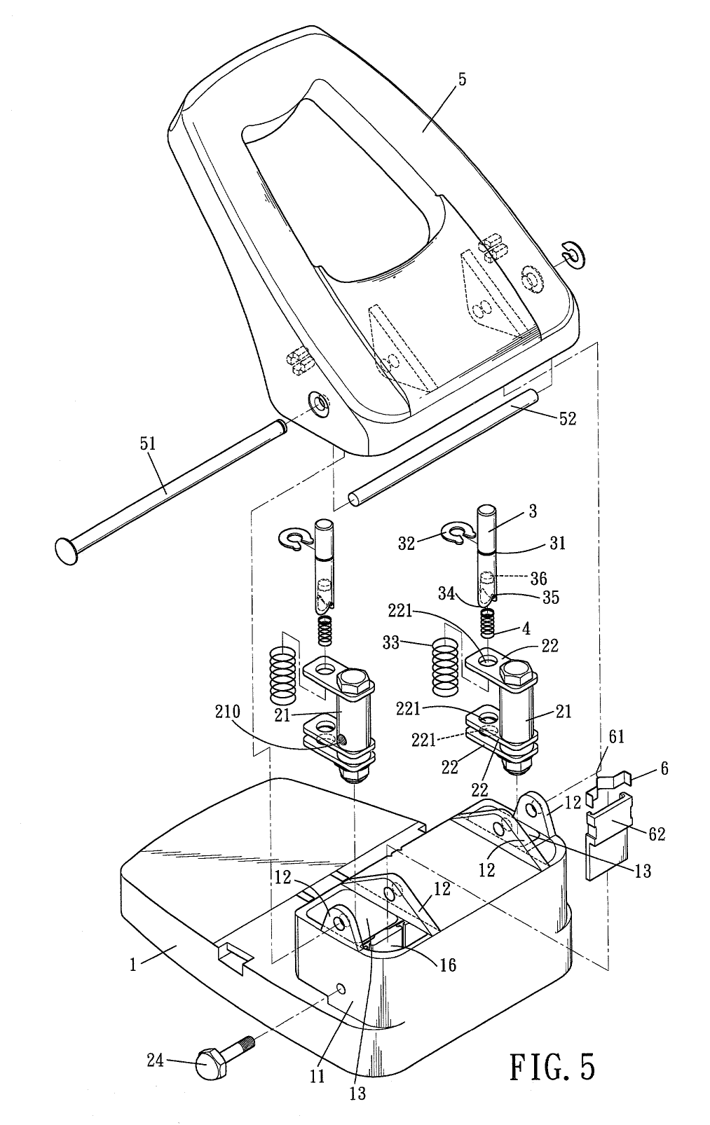

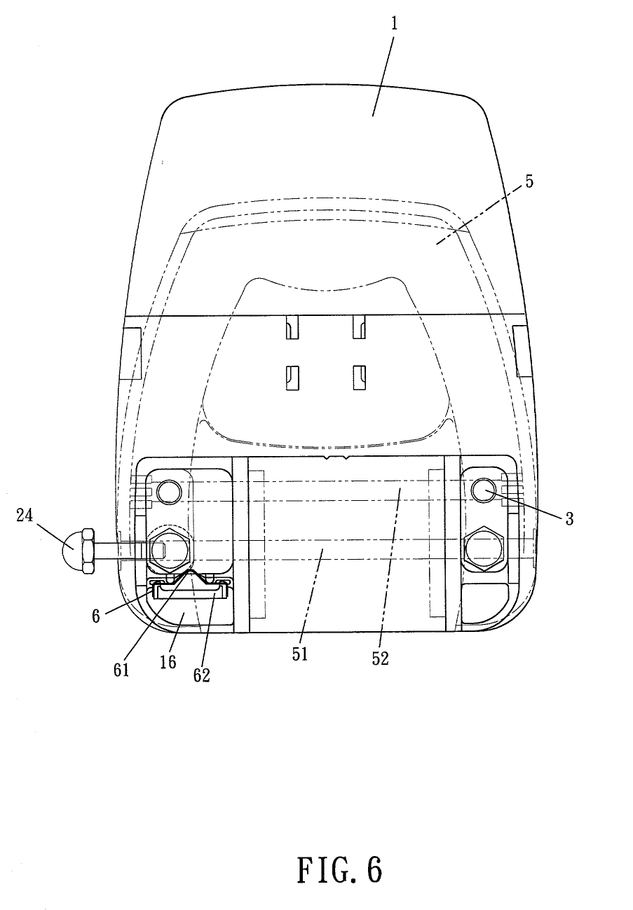

As shown in FIGS. 5 and 6, a separation plate 62 is received in one of the two passages 13 and a position member 6 is connected to the separation plate 62. A protrusion 61 extends from the position member 6. A threaded hole 210 is defined in the post 21 received in the passage 13 that has the position member 6. A rod 24 extends through the raised portion 11 and is engaged with the threaded hole 210. The post 21 having the threaded hole 210 is positioned by the protrusion 61 of the position member 6. When adjusting the position of the punch head assembly 2, the user simply pushing the rod 24 and moves the post 21 over the protrusion 61 so that the post 21 is positioned again on the other side of the protrusion 61.

While we have shown and described the embodiment in accordance with the present invention, it should be clear to those skilled in the art that further embodiments may be made without departing from the scope of the present invention.

What is claimed is:

1. A paper punch comprising:
a base and a raised portion extending from a top of said base, a gap defined between said top of said base and said raised portion, two passages defined through said raised portion;
a handle pivotally connected to said base, and
two punch head assemblies respectively received in said two passages and each punch head assembly including a post and a punch blade, a lower edge of each of said punch blades having two tips and a recess defined longitudinally in a lower end of each of said punch blade, a spring engaged in each of said recesses of said two punch blades.

2. The paper punch as claimed in claim 1, wherein said two punch blades are different in length and two respective top ends of said two punch blades are located at different levels, an operation bar located in said handle and located above said two respective top ends of said two punch blades.

3. The paper punch as claimed in claim 1, wherein a separation plate is received in one of said two passages and a position member is connected to said separation plate, a protrusion extending from said position member, a threaded hole defined in said post received in said passage that has said position member, a rod extending through said raised portion and engaged with said threaded hole, said post having said threaded hole being positioned by said protrusion of said position member.

4. The paper punch as claimed in claim 1 further comprising three plates mounted to said post of each of said punch head assemblies and said punch blade extending through said three plates, one plate mounted on a top end of said post and the other two plates mounted on a lower end of said post, a C-clamp mounted to each of said punch blades and located at an underside of said plate mounted on said top of said post, a spring mounted to said punch blade and located between said plate on said top end of said post and said two plates on said lower end of said post.
